(19) United States
(12) Patent Application Publication
(10) Pub. No.: US 2016/0375488 A1
(43) Pub. Date: Dec. 29, 2016

(54) MANUFACTURING METHOD FOR MAGNET AND MAGNET

(71) Applicant: JTEKT CORPORATION, Osaka (JP)

(72) Inventors: Takumi MIO, Kariya-shi (JP); Koji NISHI, Anjo-shi (JP); Yusuke KIMOTO, Kariya-shi (JP); Takashi TAMURA, Itami-shi (JP)

(73) Assignee: JTEKT CORPORATION, Osaka (JP)

(21) Appl. No.: 15/185,448

(22) Filed: Jun. 17, 2016

(30) Foreign Application Priority Data
Jun. 24, 2015 (JP) 2015-126531

(51) Int. Cl. B22F 3/02; B22F 1/00; H01F 41/02

(52) U.S. Cl. CPC B22F 3/02; H01F 41/0266; B22F 1/0062; B22F 2003/026

(57) ABSTRACT

A manufacturing method for a magnet has step of molding magnetic powder under pressure to obtain a molding. The magnetic powder is pressurized using a mold to which a release agent is applied. The release agent is chemical synthesis oil to which an extreme pressure additive is added.

### INCORPORATION BY REFERENCE

The disclosure of Japanese Patent Application No. 2015-126531 filed on Jun. 24, 2015 including the specification, drawings and abstract, is incorporated herein by reference in its entirety.

### BACKGROUND OF THE INVENTION

1. Field of the Invention

The invention relates to a manufacturing method for a magnet and a magnet.

2. Description of the Related Art

Japanese Patent Application Publication No. 2003-214665 (JP 2003-214665 A) describes a manufacturing method for a green compact including a filling step of filling a cavity defined by a relatively movable columnar first punch and a tubular die with coating soft-magnetic iron-based powder, a pressurizing step of pressurizing the coating soft-magnetic iron-based power into a compact, and an extracting step of extracting the compact from the cavity. JP 2003-214665 A discloses that a lubricant is placed on the coating soft-magnetic iron-based powder and/or on an area of the punch or the die (particularly an inner wall of the die 10), which comes into contact with the coating soft-magnetic iron-based powder.

When a molding is obtained by molding magnetic powder under pressure, magnetic powder particles move and are rearranged. To facilitate rearrangement of the magnetic powder particles, the magnetic powder contains a lubricant. The lubricant contained in the magnetic powder contributes to displacement of the magnetic powder particles relative to one another.

When a molding is obtained by molding magnetic powder under pressure, the magnetic powder particles and a pressurizing apparatus (die) come into sliding contact with one another. To facilitate movement of the magnetic powder particles, a lubricant (release agent) is also applied to the pressurizing apparatus (die).

JP 2003-214665 A lists the following examples of the lubricant. Typical examples of lubricants containing metal elements include metal soaps formed of lithium stearate or zinc stearate. Typical examples of lubricants containing no metal elements include solid lubricants formed of stearic acid, fatty acid amide such as lauric acid amid, stearic acid amide, or palmitic acid amide or higher fatty acid amide such as ethylene bis(stearamide). JP 2003-214665 A also lists the following examples of the lubricant: a dispersion liquid containing the solid lubricant dispersed in a liquid medium such as water, a liquid lubricant, an inorganic lubricant having a hexagonal crystal structure, for example, an inorganic substance selected from the group consisting of boron nitride, molybdenum sulfide, tungsten sulfide, and graphite.

In the related art, when magnetic powder is compressed and molded using any of the above-described lubricant, an increase in density is smaller near a portion of the molding that comes into sliding contact with the die than inside the molding. In other words, magnetic characteristics are degraded (residual magnetic flux density decreases).

### SUMMARY OF THE INVENTION

An object of the invention is to provide a manufacturing method for a magnet and a magnet that allows a high residual magnetic flux density to be achieved.

A manufacturing method for a magnet according to an aspect of the invention has molding magnetic powder under pressure to obtain a molding. The magnetic powder is pressurized using a mold to which a release agent is applied. The release agent is chemical synthesis oil to which an extreme pressure additive is added.

In the manufacturing method for a magnet according to this aspect, the molding is formed using the mold to which the lubricant that is the chemical synthesis oil with the extreme pressure additive added thereto is applied. The release agent prevents possible film breakage during molding under pressure. Since film breakage does not occur even when the mold and the magnetic powder come into sliding contact with each other during molding under pressure, displacement of the magnetic powder is not hindered. As a result, a dense molding is obtained. Therefore, a magnet with a high residual magnetic flux density can be manufactured.

A magnet according to another aspect of the invention is manufactured by the above-described manufacturing method for a magnet.

The magnet according to this aspect is manufactured by the above-described manufacturing method and thus has a high residual magnetic flux density.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating steps of a manufacturing method for a magnet according to a first embodiment;

FIG. 2 is a schematic diagram illustrating a step of mixing magnetic powder and a lubricant in the first embodiment;

FIG. 3 is a schematic diagram illustrating the step of further mixing the magnetic powder and the lubricant in the first embodiment;

FIG. 4 is a sectional view schematically illustrating that the magnetic powder and a binder have been mixed together in the first embodiment;

FIG. 5 is a schematic diagram illustrating a step of pressurizing the magnetic powder in the first embodiment where the magnetic powder has not been pressurized;

FIG. 6 is a schematic diagram illustrating the step of pressurizing the magnetic powder in the first embodiment where the magnetic powder has not been pressurized;

FIG. 7 is an enlarged view schematically illustrating an arrangement of the magnetic powder in a molding in the first embodiment;

FIG. 8 is an enlarged view schematically illustrating a configuration of the magnet according to the first embodiment;

FIG. 9 is a diagram illustrating steps of a manufacturing method for a magnet according to a second embodiment; and

FIG. 10 is a diagram illustrating a variation in temperature in a heat treatment step in the manufacturing method for a magnet according to the second embodiment.

### DETAILED DESCRIPTION OF EMBODIMENTS

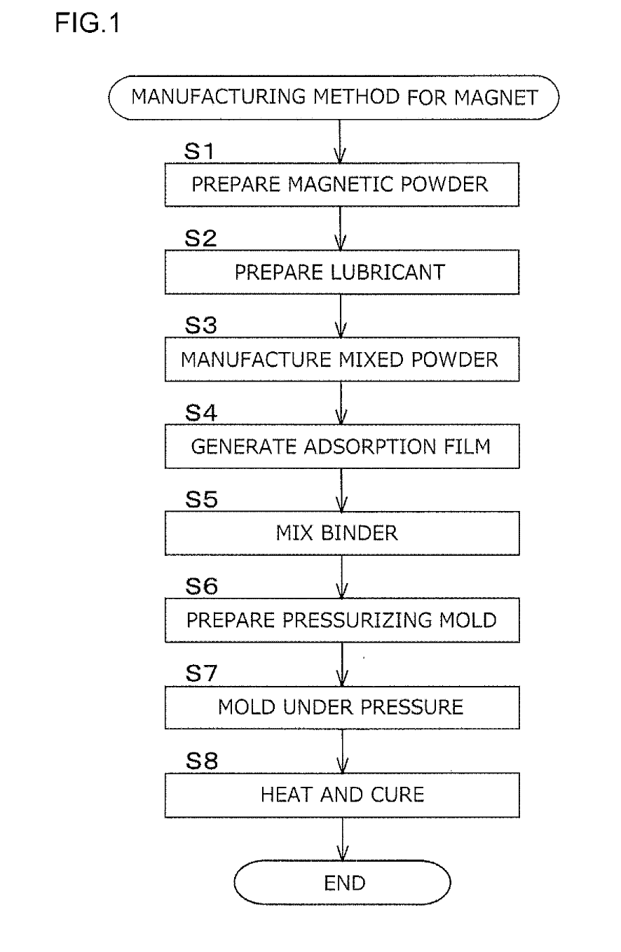

A manufacturing method for a magnet according to the invention will be specifically described as a first embodiment with reference to FIGS. 1 to 7. FIG. 1 is a chart illustrating steps of the manufacturing method for a magnet according to the present embodiment.

As illustrated in step S1 in FIG. 1, magnetic powder 1 is prepared as a material for a magnet.

The magnetic powder 1 is powder that is an aggregate of particles of a magnetic material. The magnetic material for the magnetic powder 1 is not limited but is preferably a hard magnetic substance. Examples of the hard magnetic substance include a ferrite magnet, an Al—Ni—Co-based magnet, a rare earth magnet containing rare earth elements, and an iron nitride magnet.

As the magnetic powder 1 for the hard magnetic substance, a compound containing one or more of Fe—N-based compounds and R—Fe—N-based compounds (R: rare earth elements) is preferably used. The rare earth elements represented as R may be known rare earth elements (Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr) and are preferably rare earth elements other than Dy (R; rare earth elements other than Dy). Among these rare earth elements, light rare earth elements are particularly preferable. Among the light rare earth elements, Sm is most suitable. The light rare earth elements as used herein are elements included in lanthanoids and having a smaller atomic weight than Gd, that is, La to Eu. The Fe—N-based compound is contained in an iron nitride magnet. The R—Fe—N-based compound is contained in a rare earth magnet.

A specific composition of the magnetic powder 1 is not limited as long as the magnetic powder 1 contains the Fe—N-based compound or the R—Fe—N-based compound. The magnetic powder 1 is most preferably powder of Sm₂Fe₁₇N₃ or Fe₁₆N₂.

The particle size (average particle size) of the magnetic powder 1 is not limited. The average particle size (D50) is preferably approximately 2 to 5 μm. In the magnetic powder 1 used, an oxide film is not formed all over the surfaces of particles.

As illustrated in step S2 in FIG. 1, a lubricant 2 is prepared. The lubricant 2 is a substance that is solid (solid lubricant) under normal conditions (in an air atmosphere and at room temperature). As the lubricant 2, a powdery lubricant is used.

As the lubricant 2, a metal soap-based lubricant (solid lubricant powder) is used. The lubricant 2 is, for example, powder of stearic acid-based metal such as zinc stearate. The powder of the lubricant 2 has an average particle size (D50) of approximately 10 μm. The lubricant 2 preferably has a larger average particle size than the magnetic powder 1. The lubricant 2 has a smaller specific gravity than the magnetic powder 1. When the size of the lubricant 2 is increased to some degree in an initial state, each particle of the lubricant 2 may have an increased mass, allowing the lubricant 2 to be precluded from scattering around during mixture in step S3 described later.

A mixing ratio between the magnetic powder 1 and the lubricant 2 may be optionally set. For the mixing ratio between the magnetic powder 1 and the lubricant 2, preferably, the mixed powder contains 80 to 90 vol % of magnetic powder 1 and 5% to 15 vol % of lubricant 2. Besides the magnetic powder 1 and the lubricant 2, an additive may be contained. Examples of the additive include organic solvents that may be lost on subsequent heating.

As illustrated in step S3 in FIG. 3, the magnetic powder 1 and the lubricant 2 prepared in the above-described two steps are mixed together into mixed powder.

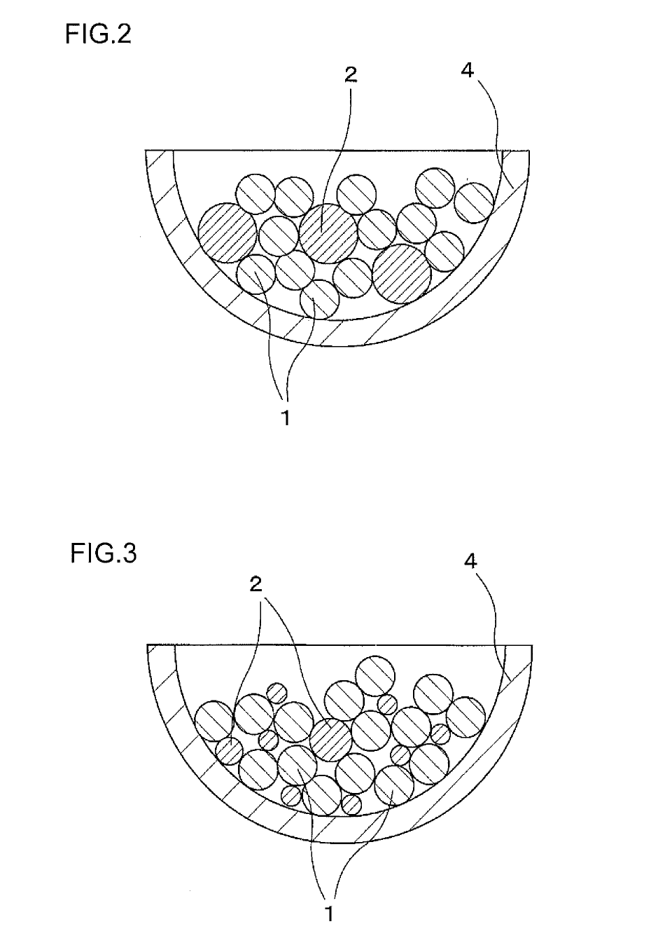

The magnetic powder 1 and the lubricant 2 are mixed together while being ground. A method for forming the mixed powder involves mixing the magnetic powder 1 and the lubricant 2 together while grinding the magnetic powder 1 and the lubricant 2, in a mixing container 4, as depicted in FIG. 2. When the magnetic powder 1 and the lubricant 2 are mixed together while being ground, the lubricant 2, which has a low binding strength, is fractionized to reduce the particle size of the lubricant 2 as a whole, as depicted in FIG. 3. At the end of step S3, particles of the lubricant 2 with different sizes are present.

Formation of the mixed powder 1 and 2 allows massive portions containing only the magnetic powder 1 to be reduced (allows secondary particles of the magnetic powder 1 to be crushed), and enables a reduction in the size of the lubricant 2. In other words, particles of the lubricant 2 resulting from fractionization can be placed in proximity to the respective particles of the magnetic powder 1.

Subsequently, as illustrated in step S4 in FIG. 1, the mixed powder 1 and 2 is heated to form an adsorption film 3 on the surface of the magnetic powder 1.

The mixed powder 1 and 2 resulting from the mixture in the above-described step (step S3) is heated at a heating temperature T₁ to form the adsorption film 3 of the lubricant 2 on the surface of the magnetic powder 1. At this time, the heating temperature T₁ for the mixed powder 1 and 2 is lower than a decomposition temperature T₂ of the magnetic powder 1 and is equal to or higher than a melting point T₃ of the lubricant 2 (T₃≦T₁<T₂).

Heating the mixed powder 1 and 2 at the heating temperature T₁ causes the lubricant 2 to be melted without decomposition of the magnetic powder 1. The melted lubricant 2 flows along the surfaces of the particles of the magnetic powder 1 to coat the surface of the magnetic powder 1. The adsorption film 3 is then formed on the surface of the magnetic powder 1. Subsequently, the mixed powder is cooled at a temperature lower than the melting point T₃ to solidify the adsorption film 3.

A heating time t at the heating temperature T₁ depends on the amount of heat applied to the mixed powder 1 and 2 and is not limited. In other words, the amount of heat applied to the mixed powder 1 and 2 per unit time increases with an increase in heating temperature T₁, enabling a reduction in heating time t. When the heating temperature T₁ is relatively low, the heating time t is preferably extended.

In connection with the heating temperature T₁ and the heating time t, an increase in the amount of heat applied to the mixed powder 1 and 2 allows the adsorption film 3 to be more aggregately generated on the surface of the magnetic powder 1. This prevents possible film breakage during a pressurizing step. Thus, a dense molding 6 and a dense magnet 9 can be manufactured.

Subsequently, as illustrated in step S5 in FIG. 1, an uncured binder 5 is placed on the surface of the magnetic powder 1 with the adsorption film 3 formed thereon.

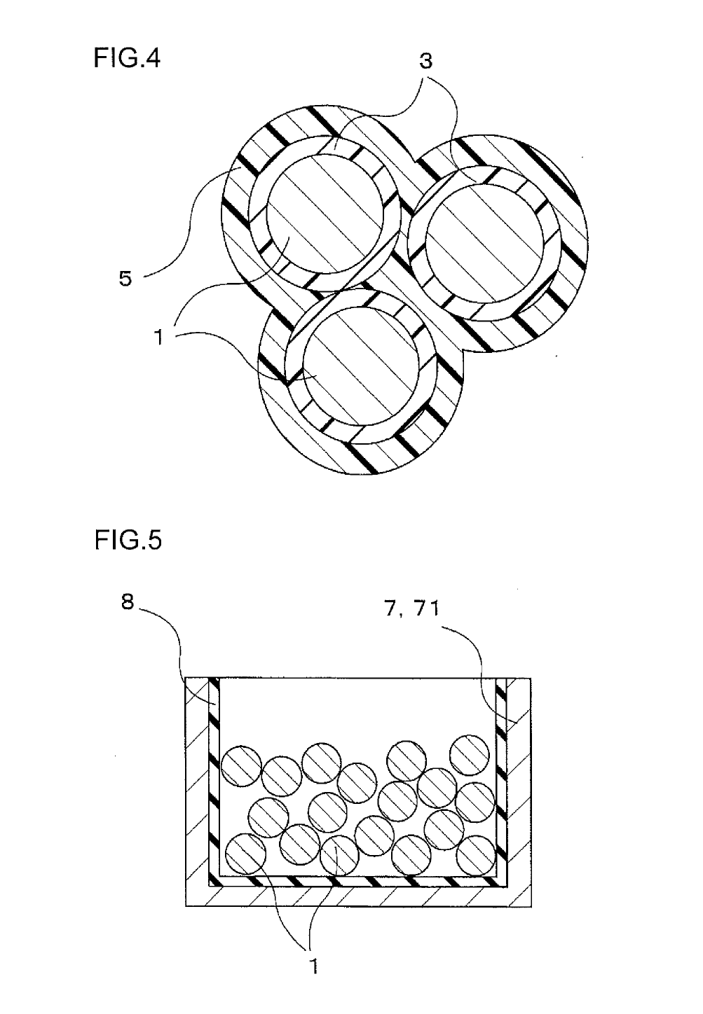

As the binder 5, an uncured binder containing a silicone composition is used. The binder 5 is gelled or liquid at room temperature and is fluid. Mixing the magnetic powder 1 with the binder 5 allows the binder 5 to be placed on the surfaces of the particles of the magnetic powder 1. In this state, as depicted in a schematic sectional view in FIG. 4, the binder 5 is interposed between the adjacent particles of the magnetic powder 1.

The silicone composition in the binder 5 is a composition having a main framework based on siloxane bonding. The silicone composition is, for example, a silicone resin. The silicone composition is uncured (gelled or liquid) when placed on the surface of the magnetic powder 1 and is cured during the subsequent step (in the present embodiment, during thermal curing in step S8).

A method for curing the binder 5 is not limited. The method involves, for example, heating the binder 5, irradiating the binder 5 with ultraviolet rays, or bringing the binder 5 with a reaction initiator such as water to start curing. The present embodiment uses a thermosetting silicone composition that is cured by heating. Compared to radiated ultraviolet rays, heat is easily transmitted to the interior of the molding 6 to allow curing to be reliably achieved.

The thermosetting silicone composition has a curing temperature (curing start temperature) T₄ that is lower than the decomposition temperature T₂ of the magnetic powder 1. The curing temperature (curing start temperature) T₄ is preferably lower than the melting point T₃ of the lubricant (T₄<T₃<T₂). The curing temperature (curing start temperature) T₄ within this range inhibits exposure of the magnetic powder 1 to temperatures higher than T₄, which may cause decomposition of the magnetic powder 1 or loss of the adsorption film 3.

The mixture rate of the binder 5 may be optionally set. For example, when the volume of the magnetic powder 1 (with the adsorption film 3 formed thereon) is defined to be 100 vol %, the mixed powder preferably contains 5 to 15 vol % of binder 5 and more preferably 8 to 12 vol % of binder 5.

Subsequently, as illustrated in step S6 in FIG. 1, a pressurizing mold 7 is prepared in which the magnetic powder 1 is pressurized to form a molding 6.

The pressurizing mold 7 includes a lower pressurizing mold 71 and an upper pressurizing mold 72. The magnetic powder 1 is molded under pressure by placing the magnetic powder 1 in a cavity in the lower pressurizing mold 71, assembling the upper pressurizing mold 72 on the lower pressurizing mold 71, and moving the lower pressurizing mold 71 and the upper pressurizing mold 72 such that the lower pressurizing mold 71 and the upper pressurizing mold 72 become closer to each other.

The pressurizing mold 7 is formed of nonmagnetic steel. The pressurizing mold 7 includes a magnetic-field orienting apparatus not depicted in the drawings so as to allow the magnetic powder 1 to be pressurized under the condition that lines of magnetic force are transmitted through the magnetic powder 1 (under the condition for magnetic field orientation).

A release agent 8 is applied to an inner surface of the pressurizing mold 7.

The release agent 8 is chemical synthesis oil to which an extreme pressure additive is added.

The chemical synthesis oil disperses the extreme pressure additive. Compared to mineral oil, the chemical synthesis oil is less likely to be oxidized (degraded) at temperatures higher than a temperature at which the mineral oil is oxidized and less likely to cause oil film breakage. Since the release agent 8 contains the chemical synthesis oil, the extreme pressure additive can be placed on a surface of the pressurizing mold 7. During pressurization, the extreme pressure additive can be placed without causing oil film breakage.

Any chemical synthesis oil may be used as long as the oil is formed by chemical synthesis. As the chemical synthesis oil, one or more chemical synthesis oils may be selected from polyolefin (polyolefin-based synthetic oil), adipate (adipate-based synthetic oil), and polyester (polyester-based synthetic oil). Adipate is bis (2-ethylhexyl) adipate and is also referred to as dioctyl adipate (DOA).

The extreme pressure additive effectively enhances lubricity in a lubrication state in which oil film breakage is likely to occur due to a high contact pressure. Since the extreme pressure additive is contained in the chemical synthesis oil that is less likely to be oxidized even at high temperature than mineral oil, the extreme pressure additive is less likely to be oxidized and exerts adequate effects.

The type of the extreme pressure additive is not limited. One or more extreme pressure additives may be selected from phosphorous-based extreme pressure additives and sulfur-based extreme pressure additives. The phosphorous-based extreme pressure additive is a compound containing phosphorous. An example of the phosphorous-based extreme pressure additive is acidic phosphoric ester, and a specific example of the acidic phosphoric ester is oleyl acid phosphate. The sulfur-based extreme pressure additive is a compound containing sulfur. An example of the sulfur-based extreme pressure additive is a sulfur compound, and a specific example of the sulfur compound is dibenzyl sulfide.

The content of the extreme pressure additive in the release agent 8 is not limited. When the volume of the release agent 8 as a whole is defined to be 100 vol %, the release agent 8 preferably contains 10 to 30 vol % of extreme pressure additive and more preferably 20 vol % of extreme pressure additive, The extreme pressure additive with a volume falling within this range allows the above-described effects to be exerted. When the release agent 8 contains an excessive amount of extreme pressure additive, the extreme pressure additive exceeds saturation and remains without being dispersed (dissolved).

Besides the chemical synthesis oil and the extreme pressure additive, the release agent 8 may contain a well-known additive. Examples of the well-known additive include an antioxidant, a viscosity modifier, and a pH adjuster.

A method for applying the release agent 8 to the surface of the pressurizing mold 7 is not limited. Spray coating, brush application, or the like may be used. An application thickness may correspond to an amount at which the extreme pressure additive can be attached to the surface of the pressurizing mold 7.

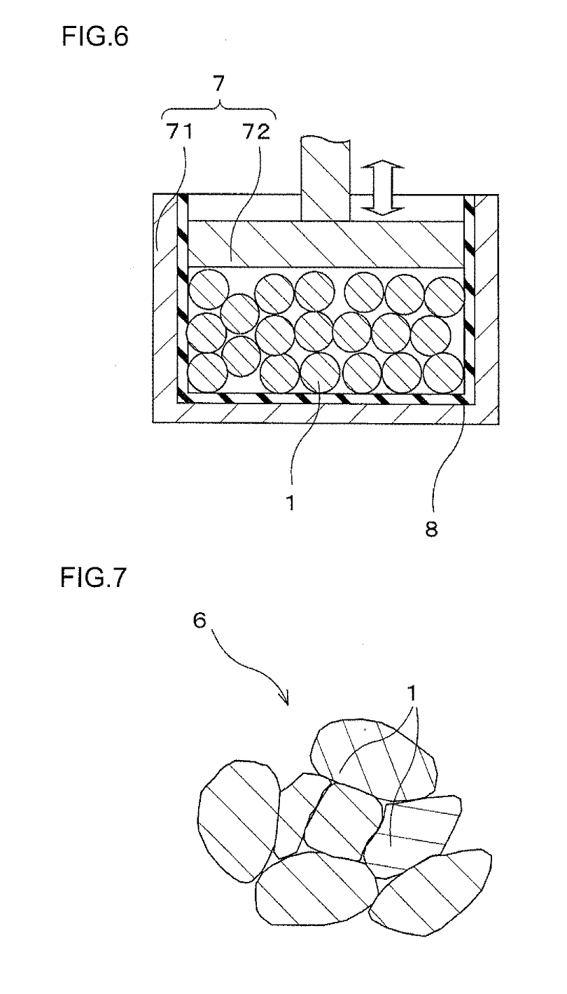

Subsequently, as illustrated in step S6 in FIG. 1, the magnetic powder 1 is pressurized to form a molding 6 (FIG. 5 and FIG. 6). In the magnetic powder 1 pressurized in the present step, the binder 5 is interposed between the particles.

In the pressurizing step, as schematically illustrated in FIG. 5, the magnetic powder 1 is placed in a cavity in a pressurizing mold 7 (lower pressurizing mold 71). The pressurizing mold 7 is formed of nonmagnetic steel. Pressurization of the pressurizing mold 7 is performed under the condition that lines of magnetic force are transmitted through the magnetic powder 1 (under the condition for magnetic field orientation).

Subsequently, as illustrated in a schematic diagram in FIG. 6, the magnetic powder 1 is molded under pressure by assembling the upper pressurizing mold 72 on the lower pressurizing mold 71 and moving the lower pressurizing mold 71 and the upper pressurizing mold 72 such that the lower pressurizing mold 71 and the upper pressurizing mold 72 become closer to each other. At this time, a pressure applied by the pressurizing mold 7 (71 and 72) is equal to or lower than a burst pressure at which the magnetic powder 1 is destroyed. In the present embodiment, the pressure is 1 GPa or lower.

Pressurization using he pressurizing mold 7 (71 and 72) is performed a plurality of times. After the pressure is applied to the upper pressurizing mold 72, the pressure applied to the upper pressurizing mold 72 is released and then, a pressure is applied to the upper pressurizing mold 72 again. This operation is repeated. To release the pressure applied to the upper pressurizing mold 72, the upper pressurizing mold 72 may be moved upward or the pressure applied to the upper pressurizing mold 72 may exclusively be reduced without upward movement of the upper pressurizing mold 72.

The number of pressurizing operations using the pressurizing mold 7 (71 and 72) may be equal to the number of pressurizing operations resulting in saturation of the effect of an increase in the density of the molding 6. For example, the number of pressurizing operations may be two to 30.

Moreover, during the pressurizing step, the magnetic powder 1 in the pressurizing mold 7 (71 and 72) is heated by heating the pressurizing mold 7 (71 and 72), for example, from an outer side surface thereof using a heater (not depicted in the drawings). At this time, a heating temperature T₅ for the magnetic powder 1 is a temperature at which the adsorption film 3 is melted and liquefied and which is lower than the curing temperature T₄ of the binder 5. The heating temperature T₅ is also lower than the decomposition temperature T₂ of the magnetic powder 1 (T₅<T₄<T₂). Therefore, even with heating, the magnetic powder 1 is not decomposed and the binder 5 is also not cured.

Repeated pressurizing operations using the pressurizing mold 7 allow formation of a molding 6 with reduced clearances between the particles of the magnetic powder 1 as illustrated in the enlarged view in FIG. 7. This is because a plurality of pressurizing operations allows arrangement of the particles of the magnetic powder 1 to be changed compared to the arrangement of the particles of the magnetic powder 1 during the last pressurizing operation.

During the rearrangement of the particles of the magnetic powder 1, the adsorption film 3 of the lubricant 2 is interposed between abutting contact surfaces (sliding contact surfaces) of the adjacent particles of the magnetic powder 1 to allow the particles of the magnetic powder 1 to move very smoothly. The clearances between the particles of the magnetic powder 1 in the molding 6 are reduced by a synergistic effect of the rearrangement of the particles of the magnetic powder 1 and sliding attributed to the adsorption film 3.

The uncured binder 5 is also interposed between the particles of the magnetic powder 1. The uncured binder 5 exhibits characteristics similar to the characteristics of silicone oil and lubricity. That is, movement (rearrangement) of the particles of the magnetic powder 1 is promoted by the adsorption film 3 and the uncured binder 5 interposed between the adjacent particles of the magnetic powder 1. This action also serves to reduce the clearances between the particles of the magnetic powder 1 in the molding 6. That is, a molding 6 is obtained which has reduced clearances between the particles of the magnetic powder 1.

Moreover, the release agent 8 is applied to the surface of the pressurizing mold 7 (particularly the lower pressurizing mold 71). The extreme pressure additive contained in the release agent 8 exhibits lubricity even under harsh conditions, for example, at temperatures or pressures higher than the temperature or pressure at which normal lubricants are used. In other words, even with a long sliding contact distance, lubricity can be achieved between the surface of the pressurizing mold 7 and the particles of the magnetic powder 1 so that rearrangement of the particles of the magnetic powder 1 is hindered. Thus, a dense molding 6 is obtained.

Subsequently, as illustrated in step S8 in FIG. 1, the molding 6 is heated to cure the binder 5.

A heating temperature T₆ for the molding 6 is equal to or higher than the curing temperature (curing start temperature) T₄ of the thermosetting silicone composition and is lower than the decomposition temperature T₂ of the magnetic powder 1. The heating temperature T₆ is preferably lower than the melting point T₃ of the lubricant 2 (T₄<T₆<T₃<T₂).

The heating in the present step is performed by heating the molding 6 at the heating temperature T₆. For example, the heating is performed by setting the temperature of the pressurizing mold 7 equal to the heating temperature T₆ without extracting, from the pressurizing mold 7, the molding 6 obtained using the pressurizing mold 7 in the above-described pressurizing step (step S6).

Alternatively, the molding 6 may be extracted from the pressurizing mold 7 and placed in a microwave heating furnace, an electric furnace, a plasma heating furnace, an induction hardening furnace, a heating furnace using an infrared heater, or the like.

The heating at the heating temperature T₆ lasts until curing of the binder 5 is completed.

Execution of the above-described steps allows the magnet 9 according to the present embodiment to be manufactured.

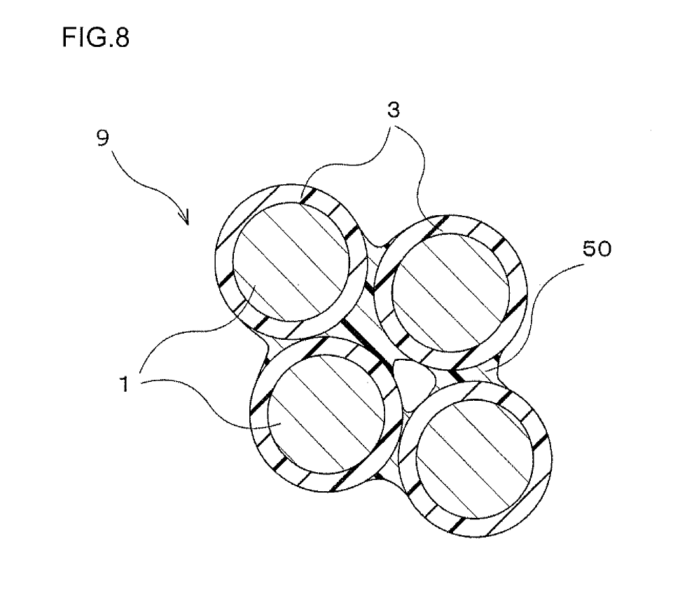

In the magnet 9 according to the present embodiment, the configuration of which is illustrated in a schematic diagram in FIG. 8, a cured binder 50 binds the particles of the magnetic powder 1 together.

The binder 50 is interposed only near the abutting contact portions of the particles of the magnetic powder 1. That is, the surfaces of the particles of the magnetic powder 1 are partly exposed. Fine voids may remain between the particles. In this case, the adsorption film 3 is formed on the surface of the magnetic powder 1, restraining the magnetic material from being exposed. In other words, it is possible to restrain degradation in the magnetic characteristics of the magnetic powder 1 due to, for example, oxidation caused by the atmosphere.

In the manufacturing method according to the present embodiment, when the magnetic powder 1 is molded in the pressurizing mold 7 to obtain the molding 6, the release agent 8 that is the chemical synthesis oil to which the extreme pressure additive is added is applied to the surface of the pressurizing mold 7. In this configuration, the release agent 8 effectively prevents regulation of movement of the particles, thereby providing the molding 6 with the particles of the magnetic powder 1 densely arranged therein.

Specifically, when the magnetic powder 1 is molded under pressure using the pressurizing mold 7 (particularly the lower pressurizing mold 71), the clearances between the particles of the magnetic powder 1 are reduced in size, resulting in the molding 6. The clearances between the particles of the magnetic powder 1 are reduced in size by rearranging the particles to decrease the relative distances between the particles.

When the magnetic powder 1 is molded under pressure using the pressurizing mold 7 (particularly the lower pressurizing mold 71), the particles of the magnetic powder 1 slide on the surface of the pressurizing mold 7 (particularly parts of the inner surface of the lower pressurizing mold 71 that are parallel to a pressurizing direction, that is, parts of the inner surface of the pressurizing mold 7 that extend in an up-down direction in FIGS. 5 and 6). This sliding contact covers a longer distance than the sliding contact between the particles of the magnetic powder 1. A long sliding contact distance causes the lubricant in the related art to suffer from oil film breakage. The oil film breakage of the lubricant prevents the particles of the magnetic powder 1 from being adequately rearranged near the abutting contact surfaces of the molding 6 and the pressurizing mold 7. This results in a partly rough molding (a molding with voids remaining near the surface thereof).

In the present embodiment, the release agent 8 is applied to the surface of the pressurizing mold 7 (particularly the lower pressurizing mold 71). The extreme pressure additive contained in the release agent 8 exhibits lubricity even under harsh conditions, for example, at temperatures or pressures higher than the temperature or pressure at which normal lubricants are used. In other words, even with a long sliding contact distance, lubricity can be achieved.

As a result, the manufacturing method according to the present embodiment allows a dense molding 6 to be obtained.

Since the chemical synthesis oil in the release agent 8 contains the extreme pressure additive, the extreme pressure additive can be interposed between the sliding contact portions during molding under pressure. Since the extreme pressure additive is contained in the chemical synthesis oil that is less likely to be oxidized even at high temperature than mineral oil, the extreme pressure additive is less likely to be oxidized and can exert adequate effects.

In the manufacturing method according to the present embodiment, the chemical synthesis oil is one or more chemical synthesis oils selected from polyolefin, adipate, and polyester. The extreme pressure additive is one or more extreme pressure additives selected from phosphorous-based extreme pressure additives and sulfur-based extreme pressure additives. This configuration allows the release agent 8 applied to the surface of the pressurizing mold 7 to reliably exhibit lubricity.

The release agent 8 in this configuration does not exhibit dispersibility with respect to the silicone composition used as the binder 5. That is, the release agent 8 does not disperse in the binder 5, which prevents the release agent 8 from moving off from the surface of the pressurizing mold 7. Thus, the release agent 8 applied to the surface of the pressurizing mold 7 can reliably exhibit lubricity. This indicates that the release agent 8 is not mixed into the binder 5 and that the release agent 8 is not contained in the magnet 9 (cured binder 50). In other words, the magnet 9 contains no impurities.

In the manufacturing method according to the present embodiment, the lubricant is placed on the surface of the magnetic powder 1. This configuration promotes movement of the particles of the magnetic powder 1 (rearrangement of the particles), providing a dense molding 6 with reduced clearances. The dense molding 6 allows a dense magnet 9 with reduced clearances to be obtained.

In the manufacturing method according to the present embodiment, the metal soap-based lubricant (stearic acid-based metal) is used as the lubricant 2. The use of this lubricant allows the adsorption film 3 of the lubricant 2 to be formed on the surface of the magnetic powder 1 by heating at the temperature T₁. The adsorption film 3 is adsorbed to the particles of the magnetic powder 1 and restrained from being peeled off (degradation of lubricity is restrained) even when the particles of the magnetic powder 1 slide on one another during the pressurizing step. This promotes movement of the particles of the magnetic powder 1 (rearrangement of the particles), reliably providing a dense molding 6 with reduced clearances.

In the manufacturing method according to the present embodiment, the pressurizing operation is performed a plurality of times during molding under pressure. This configuration promotes rearrangement of the particles of the magnetic powder 1, providing a dense molding 6 with reduced clearances.

In the manufacturing method according to the present embodiment, the silicone composition is the thermosetting silicone composition, and the molding 6 is cured by heating. This configuration allows the particles of the magnetic powder 1 to be easily bound together. The heating increases the temperature of the interior of the molding 6 so that the interior of the molding 6 can be reliably cured. That is, a possible variation in the outside shape of the molding 6 (a possible decrease in dimensional accuracy) can be suppressed.

The magnet 9 according to the present embodiment is manufactured by the above-described manufacturing method. This configuration provides a magnet that produces all of the above-described effects.

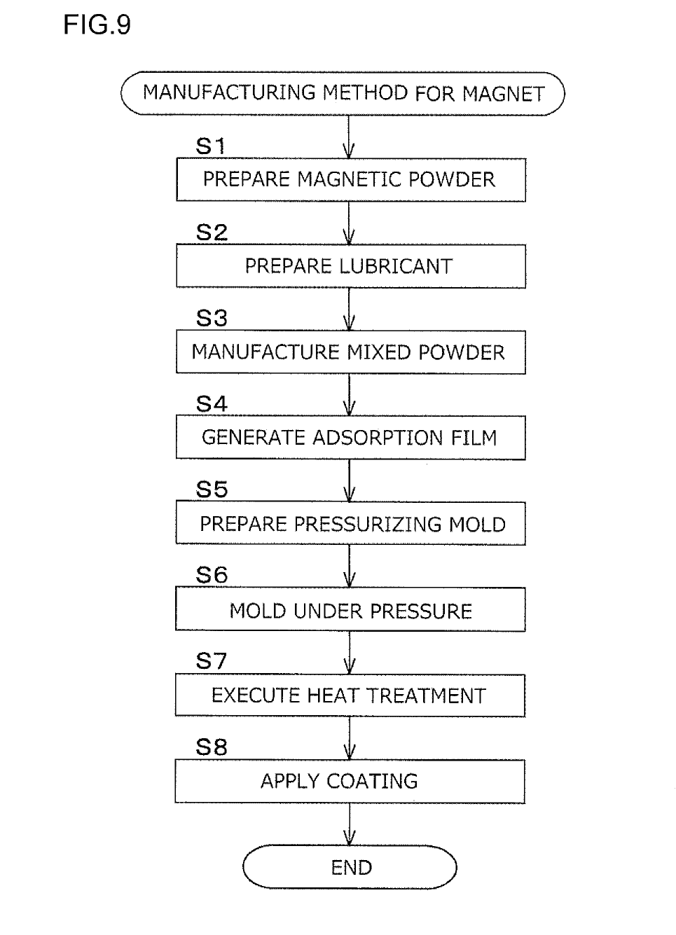

With reference to FIG. 9, a second embodiment of the manufacturing method for a magnet according to the invention will be specifically described. FIG. 9 illustrates steps of the manufacturing method for a magnet according to the present embodiment.

As illustrated in step S1 in FIG. 9, the magnetic powder 1 as a raw material for a magnet is prepared. The present step is similar to step S1 in the first embodiment.

As illustrated in step S2 in FIG. 9, the lubricant 2 is prepared. The present step is similar to step S2 in the first embodiment.

As illustrated in step S3 in FIG. 9, the magnetic powder 1 and the lubricant 2 prepared in the preceding two steps are mixed together into mixed powder. The present step is similar to step S3 in the first embodiment.

Subsequently, as illustrated in step S4 in FIG. 9, the mixed powder 1 and 2 is heated to form an adsorption film 3 on the surface of the magnetic powder 1. The present step is similar to step S4 in the first embodiment.

Subsequently, as illustrated in step S5, the pressurizing mold 7 is prepared which pressurizes the magnetic powder 1 to form the molding 6. The present step is similar to step S6 in the first embodiment.

Specifically, the pressurizing mold 7 similar to the pressurizing mold 7 in step S6 in the first embodiment is prepared, and the release agent 8 is applied to the inner surface of the pressurizing mold 7.

The release agent 8 has a composition similar to the composition of the release agent 8 in the first embodiment and contains the chemical synthesis oil to which the extreme pressure additive is added. The chemical synthesis oil and the extreme pressure additive contained in the release agent 8 have compositions similar to the compositions in the first embodiment.

Subsequently, as illustrated in step S6 in FIG. 9, the magnetic powder 1 is pressurized to form the molding 6. The present step is similar to step S7 in the first embodiment.

Specifically, the magnetic powder 1 is heated and pressurized under conditions similar to the conditions in step S7 in the first embodiment to form the molding 6.

Repetition of pressurization and depressurization allows the particles of the magnetic powder 1 to be rearranged to form the molding 6 with reduced clearances between the particles of the magnetic powder 1. During rearrangement of the particles of the magnetic powder 1, the particles of the magnetic powder 1 move very smoothly due to the adsorption film 3 of the lubricant 2 interposed between the abutting contact surfaces (sliding contact surfaces) of the adjacent particles of the magnetic powder 1. The uncured binder 5 present between the particles of the magnetic powder 1 exhibits characteristics similar to the characteristics of silicone oil and lubricity. The lubricity also promotes rearrangement of the particles of the magnetic powder 1.

When the magnetic powder 1 is molded under pressure using the pressurizing mold 7 (particularly the lower pressurizing mold 71), the particles of the magnetic powder 1 slide on the surface of the pressurizing mold 7 (particularly parts of the inner surface of the lower pressurizing mold 71 that are parallel to the pressurizing direction, that is, parts of the inner surface that extend in the up-down direction in FIGS. 5 and 6). This sliding contact covers a longer distance than the sliding contact between the particles of the magnetic powder 1. A long sliding contact distance causes the lubricant in the related art to suffer from oil film breakage. The oil film breakage of the lubricant prevents the particles of the magnetic powder 1 from being adequately rearranged near the abutting contact surfaces of the molding 6 and the pressurizing mold 7. This results in a partly rough molding (a molding with voids remaining near the surface thereof).

Also in the present embodiment, the release agent 8 is applied to the surface of the pressurizing mold 7 (particularly the lower pressurizing mold 71). The extreme pressure additive contained in the release agent 8 exhibits lubricity even under harsh conditions such as high temperature and high pressure compared to normal lubricants. In other words, even with a long sliding contact distance, lubricity can be achieved.

As a result, the manufacturing method according to the present embodiment allows a dense molding 6 to be obtained.

Since the chemical synthesis oil in the release agent 8 contains the extreme pressure additive, the extreme pressure additive can be interposed between the sliding contact portions during molding under pressure. Since the extreme pressure additive is contained in the chemical synthesis oil that is less likely to be oxidized even at high temperature than mineral oil, the extreme pressure additive is less likely to be oxidized and can exert adequate effects.

Subsequently, as illustrated in step S7 in FIG. 9, the molding 6 is heated in an oxidizing atmosphere to form a secondary molding (heat treatment step).

When the molding 6 is thermally treated in the oxidizing atmosphere, exposed surfaces of the particles of the magnetic powder 1 react with oxygen to form an oxide film on the surface of the magnetic powder 1. The oxide film joins the surfaces of the adjacent particles of the magnetic powder 1. That is, the oxide film is formed on a part of the magnetic powder 1, which is exposed to the clearance, whereas a part of the magnetic powder 1, which is not exposed to the clearance, is a base material itself (an interface where the particles are in pressure contact with each other). Therefore, the oxide film is not formed on all over the surface of the magnetic powder 1.

A secondary molding thus formed may have a sufficient strength. This enables an increase in transverse rupture strength of the secondary molding. The molding 6 has a reduced area where the magnetic powder 1 is not present, and thus, the secondary molding resulting from the heat treatment step has an increased residual magnetic flux density. The secondary molding has a density of approximately 5 to 6 g/cm³.

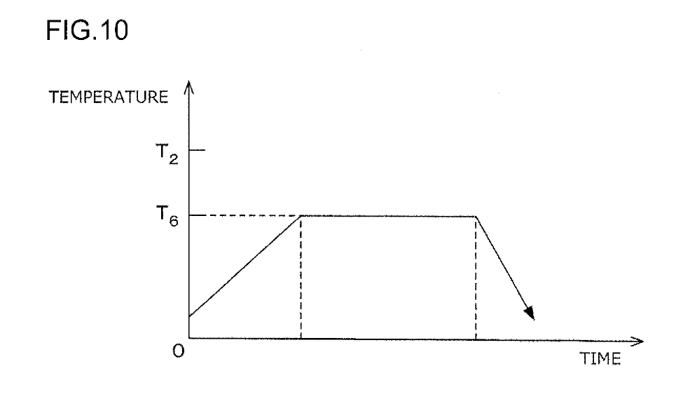

In the heat treatment step, the primary molding is placed in a microwave heating furnace, an electric furnace, a plasma heating furnace, an induction hardening furnace, a heating furnace using an infrared heater, or the like. The heating in the heat treatment step is not limited but may go through, for example, a variation in temperature illustrated in FIG. 10.

As illustrated in FIG. 10, the heating temperature T₆ is set lower than the decomposition temperature T₂ of the magnetic powder 1. For example, when Sm₂Fe₁₇N₃ or Fe₁₆N₂ is used as the magnetic powder 1, the decomposition temperature T₂ is approximately 500° C., and thus, the heating temperature T₆ is set lower than 500° C. For example, the heat treatment temperature T₆ in the present step is approximately 200 to 300° C.

An oxygen concentration and an atmospheric pressure in the oxidizing atmosphere may be set to any values as long as the oxygen concentration and the atmosphere pressure allow the magnetic powder 1 to be oxidized, The oxygen concentration and the atmospheric pressure approximately equal to the oxygen concentration in the air and the air pressure are sufficient, respectively. Thus, the oxygen concentration and the air pressure do not need to be specifically controlled. The magnetic powder 1 may be heated in the air atmosphere. The heating temperature T₆ set to approximately 200 to 300° C. allows an oxide film to be formed regardless of whether the magnetic powder is Sm₂Fe₁₇N₃ or Fe₁₆N₂.

Subsequently, as illustrated in step S8 in FIG. 9, the secondary molding formed in the heat treatment step is treated so as to cover the surface of the secondary molding with a coating film to obtain the magnet 9 according to the present embodiment.

Examples of the coating film include a plating film formed by electroplating of Cr, Zn, Ni, Ag, Cu, or the like, a plating film formed by electroless plating, a resin film formed by resin coating, a glass film formed by glass coating, and a film of diamond like carbon (DLC) or the like. An example of the electroless plating is electroless plating using Ni, Au, Ag, Cu, Sn, Co, or an alloy or a mixture thereof. An example of the resin coating is coating with a silicone resin, a fluorine resin, a urethane resin, or the like.

In other words, the coating film functions like an egg shell. Thus, the transverse rupture strength of the magnet 9 can be increased by a joining force exerted by the oxide film and the coating film. In particular, the electroless plating enables surface hardness and adhesion to be enhanced, allowing the joining force of the magnetic powder 1 to be made stronger. Electroless nickel phosphorous plating also improves corrosion resistance.

As described above, the oxide film joins the particles of the magnetic powder 1 together not only on the surface of the secondary molding but also inside the secondary molding. Therefore, inside the magnet 9, the joining force exerted by the oxide film regulates free movement of the particles of the magnetic powder 1. This suppresses inversion of magnetic polarities resulting from rotation of the magnetic powder 1. Thus, a high residual magnetic flux density can be achieved.

When the electroplating is applied in the coating step, the unplated secondary molding acts as an electrode and thus needs to have an increased joining strength. However, when the electroless plating, the resin coating, or the glass coating is applied in the coating step, the joining strength of the secondary molding need not be increased unlike the case of the electroplating, In other words, the joining force exerted by the oxide film is sufficient. Therefore, the above-described coating step allows the coating film to be reliably formed on the surface of the secondary molding.

When the electroless plating is applied in the coating step, the secondary molding is impregnated with a plating solution. At this time, the plating solution acts to enter the interior of the secondary molding, but the oxide film formed effectively suppresses the entry of the plating solution. Thus, the oxide film is expected to suppress corrosion of the secondary molding and the like resulting from the entry of the plating solution into the secondary molding.

Like the first embodiment, the present embodiment allows a dense molding 6 to be obtained. The dense molding 6 allows a dense magnet 9 to be obtained.

That is, the magnet 9 manufactured by the manufacturing method not using the binder 5 as in the present embodiment is also effective for obtaining a dense magnet 9 similarly to the first embodiment.

What is claimed is:

1. A manufacturing method for a magnet comprising:
molding magnetic powder under pressure to obtain a molding, wherein
the magnetic powder is pressurized using a mold to which a release agent is applied, and
the release agent is chemical synthesis oil to which an extreme pressure additive is added.

2. The manufacturing method for a magnet according to claim 1, wherein
the chemical synthesis oil is one or more chemical synthesis oils selected from polyolefin-based chemical synthesis oil, adipate-based chemical synthesis oil, and polyester-based chemical synthesis oil.

3. The manufacturing method for a magnet according to claim 1, wherein
the extreme pressure additive is one or more extreme pressure additives selected from a phosphorous-based extreme pressure additive and a sulfur-based extreme pressure additive.

4. The manufacturing method for a magnet according to claim 1, wherein
the magnetic powder contains a lubricant.

5. The manufacturing method for a magnet according to claim 4, wherein
the lubricant is a metal soap-based lubricant.

6. The manufacturing method for a magnet according to claim 1, wherein
the molding under pressure has a plurality of pressurizing steps.

7. A magnet manufactured by the manufacturing method for a magnet according to claim 1.
